(19) United States
(12) Patent Application Publication
(10) Pub. No.: US 2006/0063643 A1
(43) Pub. Date: Mar. 23, 2006

(54) Manual brake auxiliary system for stick shift gear change type vehicle

(76) Inventor: Shih-Hsiung Li, Taipei (TW)

Correspondence Address: DELLETT & WALTERS, P. O. BOX 82788, PORTLAND, OR, 97282-0788, US

(21) Appl. No.: 10/945,630

(22) Filed: Sep. 20, 2004

(51) Int. Cl. B60K 41/04

(52) U.S. Cl. 477/190

(57) ABSTRACT

An auxiliary system for a manual brake in a vehicle includes a gear-shifting stick monitoring device (11) for monitoring a position of the gear-shifting stick in a vehicle, an orientation sensing device (12) for sensing orientation of the vehicle, a server for controlling activation of the manual brake of the vehicle via a motor and a controlling unit (10) to receive and analyze signals from the gear-shifting stick monitoring device (11) and the orientation sensing device (12) for control of the manual brake via the server which is connected to an output of the controlling unit (10).

### BACKGROUND OF THE INVENTION

1. Field of the Invention

The present invention relates to a manual brake auxiliary system, and more particularly to a manual brake auxiliary system for stick shift gear change type vehicle to automatically stop movement of the vehicle when the driver is not at the driver's seat and the manual brake is not engaged.

2. Description of Related Art

Automobiles regardless of stick-shift gear change type or the automatic type are introduced to the world to bring fast paced lifestyle and convenience to the people. Distance seems not to be a problem between two persons far away from each other because of the convenient transportation opportunities we now have.

However, despite all the conveniences we have in our lives due to the introduction of cars, there is still something which is not so convenient to the user (the driver). That is, whenever the car is stopped, the driver has to apply the manual brake before leaving the car, otherwise, the car may move due to the slope of the road. If the driver forgets to apply the manual brake, the car might be damaged or even endanger a passersby. This kind of danger originates from the total dependence to the driver's concern to safety and the danger arising from a driver's forgetfulness is not addressed.

To overcome the shortcomings, the present invention tends to provide an improved auxiliary braking system to mitigate the aforementioned problems.

### SUMMARY OF THE INVENTION

The primary objective of the present invention is to provide an improved manual brake auxiliary system for stick shift gear type vehicle to monitor existence of coherency between the manual brake and the position of the manual brake automatically stop the vehicle from movement.

In order to accomplish the foregoing objective, the system of the present invention includes the following elements:
a gear-shifting stick monitoring device for monitoring a position of a stick shift in a vehicle;
an orientation sensing device for sensing orientation of the vehicle;
a server for controlling activation of a manual brake of the vehicle via a motor; and
a controlling unit to receive and analyze signals from the manual brake monitoring device and the orientation sensing device to control the manual brake via the server which is connected to an output of the controlling unit,
whereby when the position of the stick shift is not in accordance with the position of the manual brake, the controlling unit will activate the manual brake to stop movement of the vehicle via the server.

A further advantage of the invention is that the controlling unit has a pushbutton operably connected to the controlling unit to allow the driver to manually engage/disengage the braking system.

A further advantage of the present invention is that the system has a spirit level operably connected to the controlling unit to monitor inclination of the vehicle with reference to sea level.

Another advantage of the present invention is that the controlling unit further monitors whether the vehicle ignition system is off.

Still, a further advantage of the present invention is that the auxiliary system further has an indicator operably connected to an output of the controlling unit to send either visually or acoustically a signal to the driver.

A further advantage of the present invention is that whenever there is no driver at the driver's seat, the auxiliary system is automatically activated.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing the possible locations inside a vehicle to mount the auxiliary system of the present invention;

FIG. 2 is a block diagram of the auxiliary system of the present invention; and

FIG. 3 is a circuit diagram of the auxiliary system of the present invention, wherein the entire circuit diagram is divided into three sub-diagrams, namely FIG. 3A, FIG. 3B and FIG. 3C.

### DETAILED DESCRIPTION OF THE PREFERRED EMBODIMENT

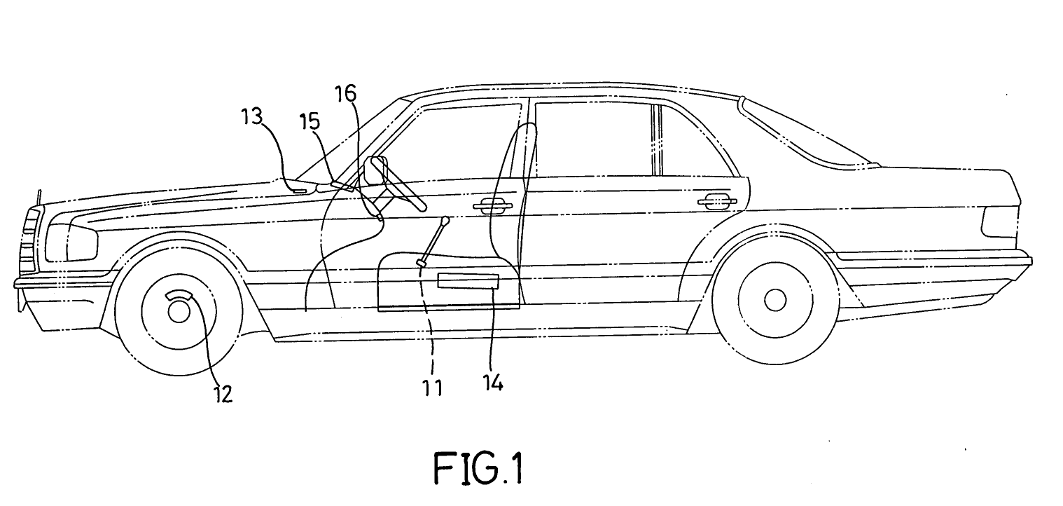

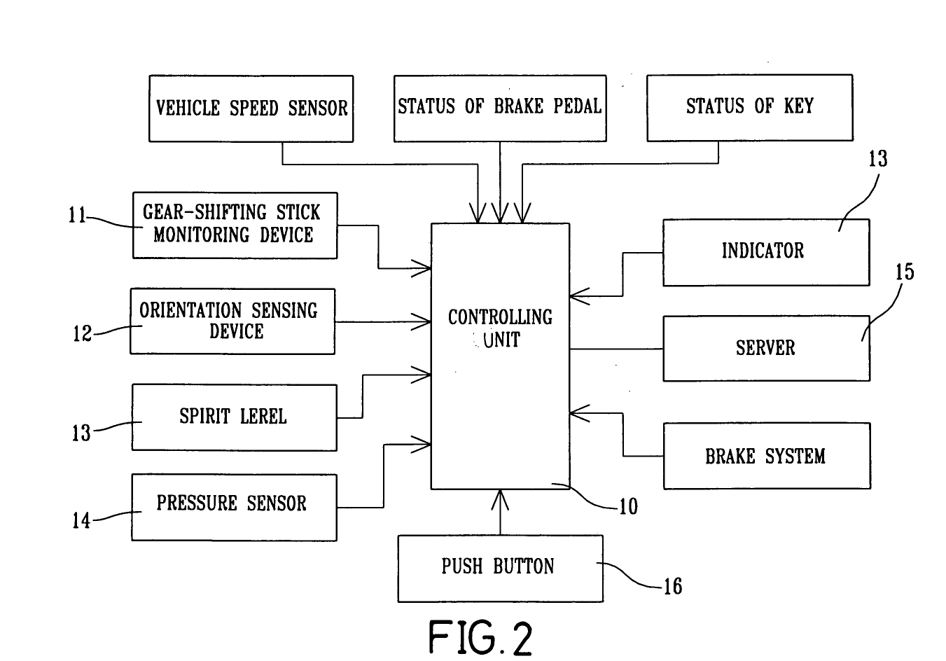

With reference to FIG. 1, the manual brake auxiliary system for a stick shift gear type vehicle having therein a manual brake, an ignition system and a gear-shifting stick and constructed in accordance with the present invention includes:
a gear-shifting stick monitoring device (11) for monitoring a position (e.g. reverse, neutral and gears 1-6) of the gear-shifting stick in a vehicle;
an orientation sensing device (12) for sensing orientation of the vehicle, wherein the orientation sensing device (12) is mounted on one of the wheels of the vehicle so as to determine whether the vehicle is moving forward or rearward;
a spirit level (13) for examining inclination of the vehicle so as to determine whether the vehicle is positioned on any kind of slopes;
a pressure sensor (14) adapted to be mounted inside the driver's seat for sensing the pressure change when the driver is on or away from the driver's seat and sending a message to a controlling unit for further consideration;
an indicator (15) operably connected to an output of the controlling unit to send either visually or acoustically a signal to the driver;
a pushbutton (16) for alternatively activating/deactivating the manual brake;
a server (not shown) for controlling activation of the manual brake of the vehicle via a motor; and
a controlling unit (10) to receive and analyze signals from the gear-shifting stick monitoring device (11), the orientation sensing device (12), the spirit level (13) and the pressure sensor (14) to control the manual brake via the server which is connected to an output of the controlling unit. From the depiction of FIGS. 1 and 2, it is noted that beside the connection to the gear-shifting stick monitoring device (11), the orientation sensing device (12), the spirit level (13) and the pressure sensor (14) to control the manual brake via the server, the controlling unit (10) further receives a signal from a vehicle speed sensor (VSS) to determine whether the vehicle is moving or not.

Still further the controlling unit (10) is able to sense whether the brake pedal and the ignition system in the vehicle are engaged.

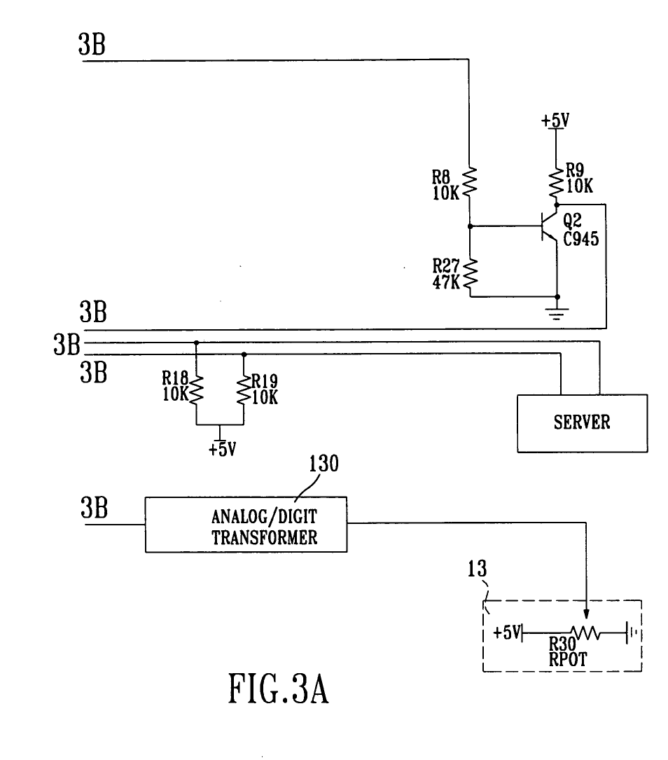

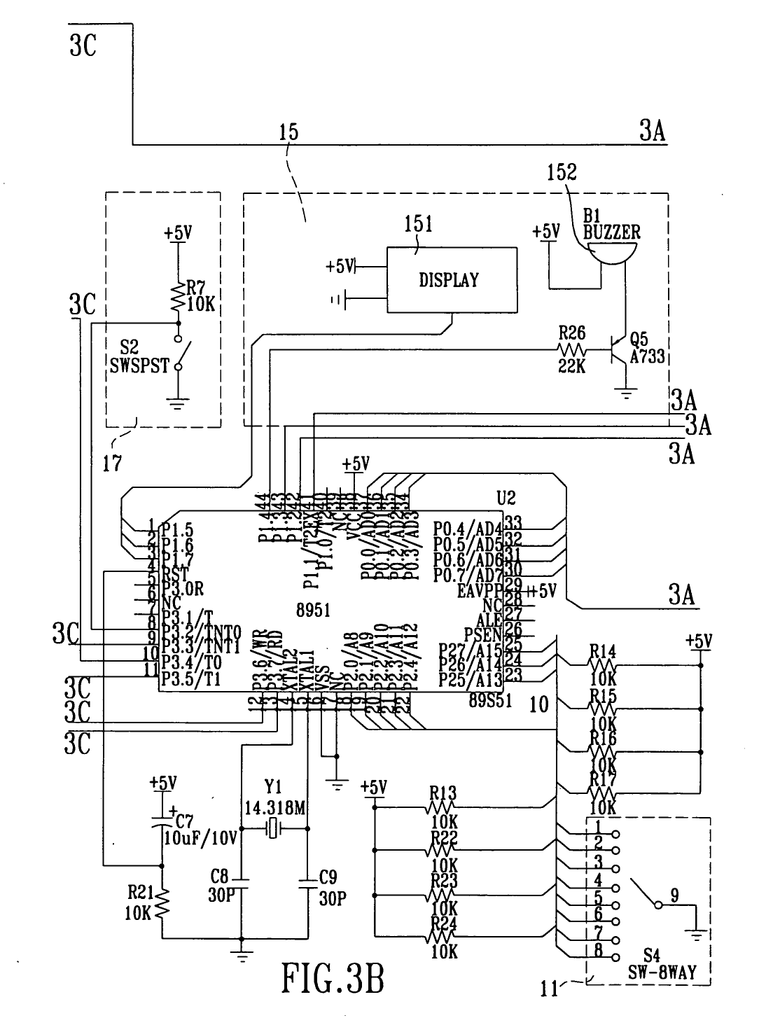

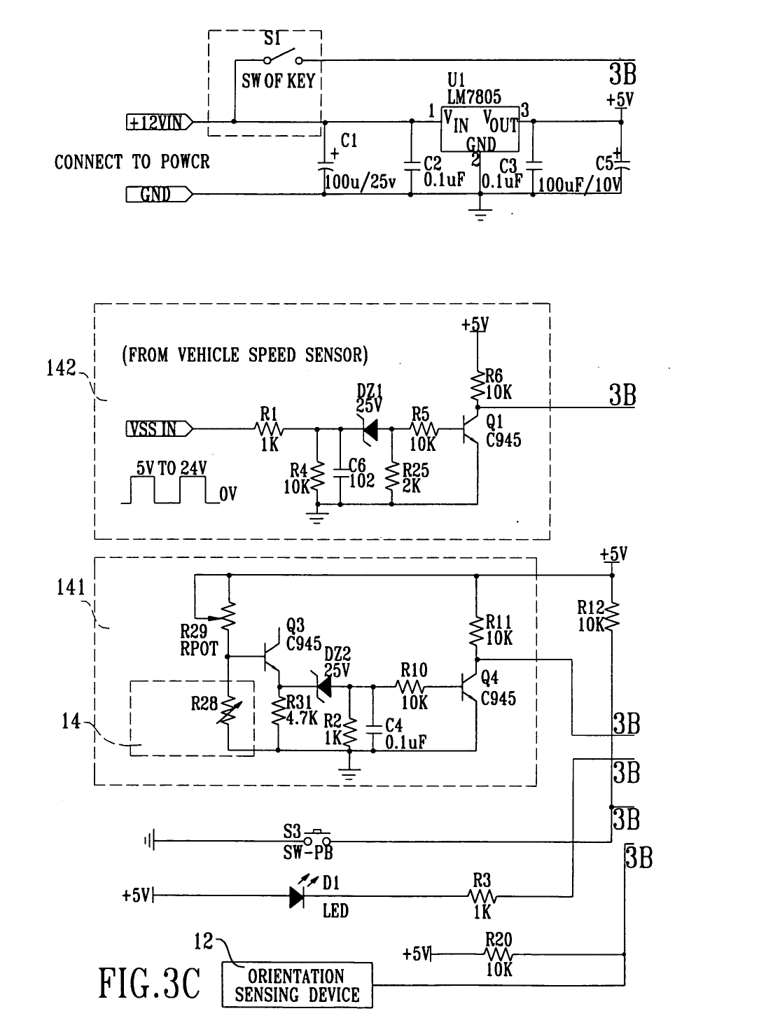

With reference to FIG. 3 and FIGS. 3A, 3B and 3C as well, the controlling unit (10) is a 8951 microprocessor. Inputs of the controlling unit (10) are respectively connected to the gear-shifting stick monitoring device (11), the orientation sensing device (12), the spirit level (13), the pressure sensor (14), the indicator (15), the pushbutton (16) and the server, wherein the spirit level (13) is connected to a corresponding one of the inputs of the controlling unit (10) via an analog/digit transformer (130), the pressure sensor (14) is connected to the controlling unit (10) via a transforming circuit (141), the VSS signal is connected with the controlling unit (10) via a transforming circuit (142). In this preferred embodiment of the present invention, the indicator (15) is composed of a display (151) and a buzzer (152). Both the display (151) and the buzzer (152) are connected to outputs of the controlling unit (10) to visually or acoustically remind the driver of the current vehicle conditions.

One of the inputs is controlled by a switch (17) to sense whether the brake pedal is engaged and one of the outputs of the controlling unit (10) is connected to the onboard manual brake.

Therefore, it is noted that the controlling unit (10) continuously examines the conditions of the orientation sensing device (12) and the pressure sensor (14). If the pressure sensor (14) detects that the driver is not at the driver's seat and the orientation sensing device (12) detects that the vehicle is moving, the vehicle is not moving normally. Thus the controlling unit (10) will automatically engage the manual brake to force the vehicle to stop movement.

If the vehicle is moving rearward (the gear shifting stick is at the reverse gear) and the orientation sensing device (12) detects that the vehicle is moving forward, the vehicle is moving abnormally, the controlling unit (10) will automatically engage the manual brake to force the vehicle to stop movement.

In a condition where the vehicle is moving rearward and the gear shifting stick is at the forward gear, the vehicle is not moving normally. Therefore, the controlling unit (10) will automatically engage the manual brake to force the vehicle to stop movement.

Still, in a condition where the vehicle is moving (forward or rearward) and the gear shifting stick is at the neutral gear, the vehicle is moving abnormally, the controlling unit (10) will automatically engage the manual brake to force the vehicle to stop movement.

Furthermore, if the pressure sensor (14) detects that the driver is not at the driver's seat and the orientation sensing device (12) detects that the vehicle is moving, the controlling unit (10) automatically forces the vehicle to stop via the server.

If the driver is detected to be at the driver's seat and the brake pedal is detected to be in a status of engagement by the controlling unit (10), when the ignition system is detected to be at a status of OFF, the controlling unit (10) will still engage the manual brake via the server. The status of engagement of both the brake pedal and the manual brake will be displayed on the display (151) and the buzzer (152) will sound an alarm to remind the driver.

In a situation where the brake pedal is engaged and the manual brake is also engaged, the controlling unit (10) monitors the status change of the pushbutton (16). If the pushbutton (16) is engaged by the driver, the engagement of the manual brake is disengaged. However, before the engagement of the pushbutton (16), if the manual brake is already disengaged, the engagement of the pushbutton (16) will enact the controlling unit (10) to engage the manual brake.

Still further, if the pushbutton (16) is pressed over a predetermined time period (i.e. ten seconds), the engagement of the manual brake will be disengaged whether the driver is at the driver's seat. Meanwhile, the indicator (15) shows the current vehicle situation. Such a scenario applies only when the vehicle experiences a malfunction and is towed.

Therefore, the auxiliary system of the present invention examines whether the position of the gear shifting stick is in accordance with the vehicle's movement orientation to determine the engagement of the manual brake so as to force the vehicle to a full stop. Furthermore, if the driver gets off the vehicle without the engagement of the manual brake, the controlling unit (10) will automatically engage the manual brake if the vehicle is detected to be in a status of movement.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An auxiliary system for a stick shift gear change vehicle having a gear-shifting stick, a manual brake, an ignition system, a driver's seat and a brake pedal, the auxiliary system having
a gear-shifting stick monitoring device (11) for monitoring a position of the gear-shifting stick in a vehicle;
an orientation sensing device (12) for sensing orientation of the vehicle;
a server for controlling activation of the manual brake of the vehicle via a motor; and
a controlling unit (10) to receive and analyze signals from the gear-shifting stick monitoring device (11) and the orientation sensing device (12) for control of the manual brake via the server which is connected to an output of the controlling unit (10).

2. The auxiliary system as claimed in claim 1 further comprising a spirit level (13) operably connected to the controlling unit for examining inclination of the vehicle so as to determine whether the vehicle is positioned on any kind of slopes and send a signal to the controlling unit.

3. The auxiliary system as claimed in claim 2, wherein the spirit level (13) is connected to the controlling unit (10) via an analog/digital transformer (130).

4. The auxiliary system as claimed in claim 3 further comprising a pressure sensor (14) operably connected to the controlling unit (10) for examination of pressure change of the driver's seat to determine whether a driver is at the driver's seat and send a signal to the controlling unit.

5. The auxiliary system as claimed in claim 4, wherein the controlling unit (10) receives a signal from a vehicle speed sensor for determination of whether the vehicle is moving.

6. The auxiliary system as claimed in claim 5, wherein signals from the vehicle speed sensor and the pressure sensor (14) are transmitted to the controlling unit via a transforming unit (142,141) respectively.

7. The auxiliary system as claimed in claim 4, wherein the controlling unit (10) is adapted for connection to the ignition system so as to determine whether the ignition system is engaged.

8. The auxiliary system as claimed in claim 7, wherein the controlling unit (10) is adapted for connected to the brake pedal so as to determine whether the brake pedal is engaged.

9. The auxiliary system as claimed in claim 7, wherein an indicator (15) is connected to a corresponding one of outputs of the controlling unit (10) to visually and/or acoustically send out a signal.

10. The auxiliary system as claimed in claim 9, wherein the indicator (15) is composed of a display (151) and a buzzer (152) respectively connected to corresponding two of the outputs of the controlling unit (10).

11. The auxiliary system as claimed in claim 1 further comprising a pushbutton (16) operably connected to the controlling unit for manually engaging/disengaging the manual brake.
